(19) United States
(12) Patent Application Publication
(10) Pub. No.: US 2015/0069953 A1
(43) Pub. Date: Mar. 12, 2015

(54) CHARGING SYSTEM AND METHOD OF BATTERY

(71) Applicant: Hyundai Motor Company, Seoul (KR)

(72) Inventors: Hyun Wook Seong, Seoul (KR); Mu Shin Kwak, Osan (KR); Shin Hye Chun, Gwangyang (KR); Hui Sung Jang, Hwaseong (KR)

(73) Assignee: HYUNDAI MOTOR COMPANY, Seoul (KR)

(21) Appl. No.: 14/085,137

(22) Filed: Nov. 20, 2013

(30) Foreign Application Priority Data
Sep. 12, 2013 (KR) 10-2013-0110019

(51) Int. Cl. B60L 11/18; H02J 7/00

(52) U.S. Cl. CPC B60L 11/1812; H02J 7/007
USPC 320/107; 320/162

(57) ABSTRACT

A charging system and method of a battery are provided. The charging system includes a PFC (power factor correction) converter that converts alternating current input voltage into direct current input voltage and outputs the direct current voltage, and corrects a power factor. A DC-DC (direct current-direct current) converter varies the levels of direct current voltage output from the PFC converter and a battery is charged with the current output from the DC-DC converter. In addition, a controller is configured to adjust an output voltage of the PFC converter based on a charging voltage of the battery, which is varied by the charging and discharging of the battery.

### CROSS-REFERENCE TO RELATED APPLICATION

The present application claims priority to Korean Patent Application No. 10-2013-0110019 filed on Sep. 12, 2013, the entire contents of which is incorporated herein for all purposes by this reference.

### BACKGROUND

(a) Technical Field

The present disclosure relates to a charging system and method of a battery for controlling the charging of a high voltage battery for a vehicle, and more particularly, to a system and method for controlling the charging of a battery to maximize a charging efficiency of a battery by varying an input voltage of a direct current converter based on a charging voltage of a high voltage battery.

(b) Background Art

Generally, duty of a converter has to be used at a maximum level to adjust high efficiency in a topology where a full bridge type or a half-bridge type is adopted to a power saving-type direct current-direct current (DC-DC) converter. Currently, a charging method of a battery has been used in which an output voltage at a terminal of Power Factor Correction (PFC) of an on board charger that is mounted within a vehicle is controlled as a predetermined value. However, the duty is not used at a maximum level at a terminal of the power saving type-DC-DC converter when a charging voltage of a battery is low, and thus loss due to circulating current may increase. This drawback affects the efficiency of an on board charger and may cause overall efficiency loss to decrease thereby increasing charging time.

The description provided above as a related art of the present invention is merely for helping understanding the background of the present invention and should not be construed as being included in the related art known by those skilled in the art.

### SUMMARY

The present invention provides a charging system and method of a battery in which an output voltage of a PFC terminal may be controlled to be an input voltage of a terminal of a DC-DC converter with a maximum duty based on the charging information of a battery.

A charging system of a battery according to an exemplary embodiment of the present invention may include: a PFC (Power Factor Correction) converter that converts alternating current (AC) input voltage into direct current (DC) voltage and outputs the DC voltage, and corrects a power factor; a DC-DC converter that varies levels of direct current voltage output from the PFC converter; a battery configured to be charged with a current output from the DC-DC converter; and a controller configured to adjust an output voltage of the PFC converter based on a charging voltage of the battery, which may be varied by the charging and discharging of a battery.

The controller may be configured to adjust an available duty value of the DC-DC converter to be maximized by adjusting the output voltage of the PFC converter. An input voltage of the DC-DC converter may be substantially similar to the output voltage of the PFC converter. In addition, the controller may be configured to adjust (e.g., control) the output voltage of the PFC converter to be decreased as the charging voltage of the battery becomes substantially low.

A charging method of a battery according to an exemplary embodiment of the present invention may include: detecting a charging voltage of a battery; and adjusting an output voltage of the PFC converter which converts alternating current input voltage into direct current voltage and outputs the DC voltage based on the detected charging voltage.

The charging method of a battery may further include maximizing an available duty value of the DC-DC converter which uses the output voltage of the PFC converter as an input voltage based on the controlled output voltage of the PFC converter. The input voltage of the DC-DC converter may be substantially similar to the controlled output voltage of the PFC converter. The output voltage of the PFC converter may be controlled to be reduced as the charging voltage of the battery becomes substantially low relatively.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exemplary view showing a charging system of a battery according to an exemplary embodiment of the present invention;

FIGS. 2A to 2C are exemplary graphs showing an output voltage of a PFC converter, a duty value of a DC-DC converter and a charging voltage of a battery under a charging method according to an exemplary embodiment of the present invention, comparing to a conventional charging method; and

FIG. 3 is an exemplary flowchart of a charging method of a battery according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles, and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN). The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It should be understood that the accompanying drawings are not necessarily to scale, presenting a somewhat simplified representation of various exemplary features illustrative of the basic principles of the invention. In the figures, the same reference numerals will be used throughout the drawings and the description to refer to the same or like parts.

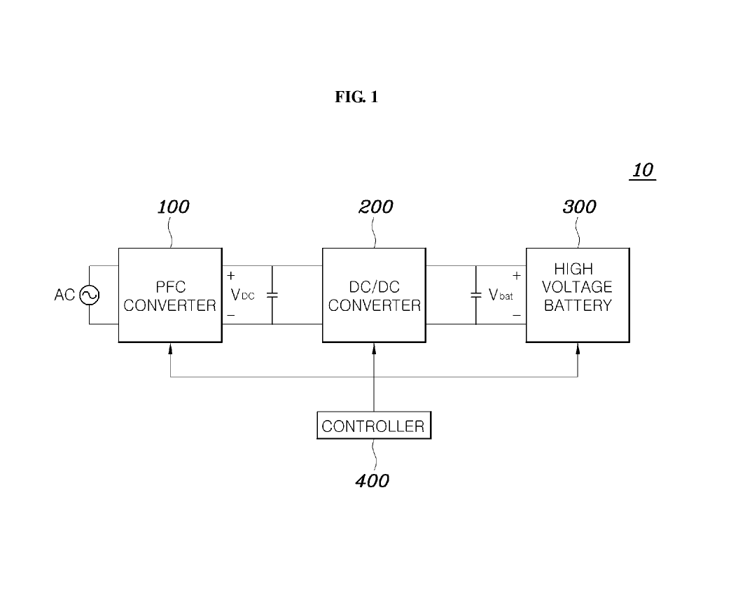

FIG. 1 is an exemplary view showing a charging system of a battery according to an exemplary embodiment of the present invention. A charging system 10 of a battery may include a PFC converter 100, a DC-DC converter 200, a high voltage battery 300 and a controller 400.

The PFC converter 100 may be configured to convert alternating current (AC) input voltage into direct current (DC) voltage and simultaneously correct power factor of voltage. In other words, the PFC converter 100 may be configured to perform rectification of converting alternating current voltage into direct current voltage and increase power factor by reducing phase shift between input current and input voltage.

The DC-DC converter 200 may be a power saving type DC-DC converter and shaped as a full-bridge structure or half-bridge structure and may be configured to vary levels of direct current voltage output from the PFC converter 100. According to an exemplary embodiment of the present invention, the DC-DC converter 200 may be configured to increase a charging voltage of the high voltage battery 300 by allowing the current to flow to the high voltage battery 300. The value of output voltage of the DC-DC converter 200 may be substantially similar to an open circuit voltage at the high voltage battery 300, and the open circuit voltage may be substantially similar to the charging voltage of the high voltage battery 300. A relation between the charging voltage Vbat of the high voltage battery 300 and an input voltage of the DC-DC converter 200 is expressed by the following equation.

$${V}_{DC} = {V}_{bat} \frac{n}{{D}_{eff}} \qquad Equation 1$$

In Equation 1, V_{DC} is an output voltage of the PFC converter 100 and at the same time it is an input voltage of the DC-DC converter 200; Vbat is a charging voltage to indicate a charging state of the high voltage battery 300; n indicates a ratio of primary wound wire and secondary wound wire contained in the DC-DC converter 200; and Deff indicates duty value between 0 and 1.

The high voltage battery 300 may be charged by the DC-DC converter 200 wherein the high voltage battery 300 may be charged and discharged to have the charging voltage in a range of about 240-413 V. In particular, when the charging voltage of the high voltage battery 300 is a predetermined value or less, the high voltage battery 300 may be charged and when the charging voltage of the high voltage battery 300 is about 413 V, the high voltage battery may be determined as a fully charged state.

When the charging voltage Vbat of the high voltage battery 300 is detected by a voltage sensing element (not shown), the controller 400 may be configured to adjust the output voltage of the PFC converter 100 based on the detected output voltage of the high voltage battery 300. The output voltage of the PFC converter 100 may be substantially similar to the input voltage of the DC-DC converter 200 and the controller 400 may be configured to operate the DC-DC converter 200 to have available maximum duty value based on the relation of the output voltage of the PFC converter 100 and Equation 1.

According to a related art, the output voltage VDC of the PFC converter 100 is fixed to 400V, and thus when the charging voltage of the high voltage battery 300 is substantially low, the duty value of the DC-DC converter 200 becomes low, as indicated in Equation 1, causing inefficient effect in terms of energy efficiency.

However, according to an exemplary embodiment of the present invention, the output voltage VDC of the PFC converter 100 may be adjusted based on the sensed charging voltage of the high voltage battery 300 to maximize the available duty value of the DC-DC converter 200. As an example, the controller 400 may be configured to adjust the output voltage of the PFC converter 100 to be reduced when the charging voltage of the high voltage battery 300 is less than a predetermined reference value rather than when the charging voltage of the high voltage battery 300 is greater than the predetermined reference value. For example, when the detected charging voltage of the high voltage battery 300 is less than about 330 V and when the detected charging voltage of the high voltage battery 300 is about 330 V or greater, with respect to the charging voltage at levels of about 240-413 V, and the output voltage VDC of the PFC converter 100 when the detected charging voltage is less than about 330 V may be adjusted to be lower than the output voltage VDC of the PFC converter 100 when the detected charging voltage is about 330 V or greater.

Further, according to another exemplary embodiment of the present invention, when the charging voltage of the high voltage battery 300 is substantially low, the output voltage of the PFC converter 100 may be reduced by the controller since the output voltage VDC of the PFC converter 100 may be substantially low when the charging voltage of the high voltage battery 300 is substantially low to increase the duty value of the DC-DC converter 200, referring to Equation 1.

Through this configuration of the system for controlling the charging voltage of a battery, the battery may be charged at a higher (e.g., improved) efficiency in a full range of the charging voltage thereof thus, decreasing the charging time and improving fuel ratio of a hybrid or fuel cell vehicle.

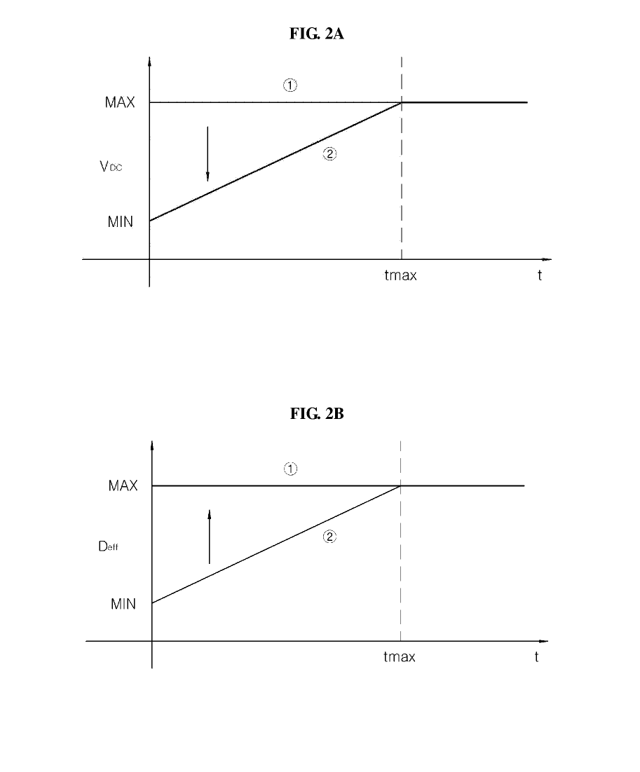

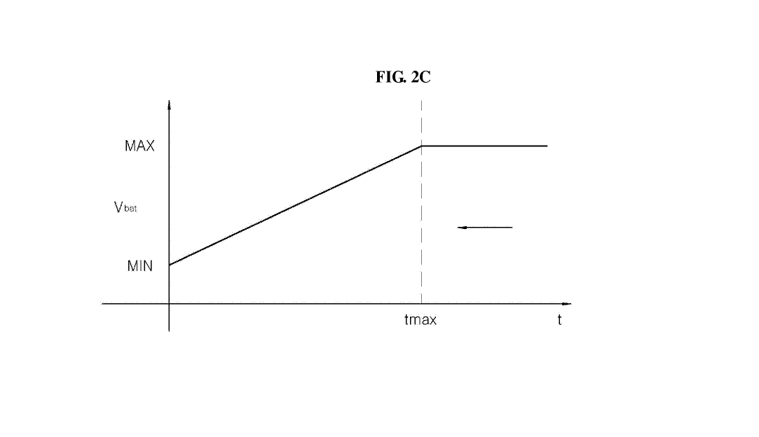

FIGS. 2A to 2C are exemplary graphs showing an output voltage of a PFC converter, a duty value of a DC-DC converter and a charging voltage of a battery under a charging method according to an exemplary embodiment of the present invention, comparing to a conventional charging method.

A graph indicated with \textcircled{1} represents a conventional charging method where the output voltage VDC of the PFC converter 100 is fixed as a predetermined value, and a graph indicated with \textcircled{2} represents a charging method according to an exemplary embodiment of the present invention where the value of the output voltage VDC of the PFC converter 100 is varied by the controller based on the charging voltage of the high voltage battery 300.

Referring to FIGS. 2A to 2C, the output voltage VDC of the PFC converter 100 may be increased linearly to reach to a maximum value for the charging method of a battery according to an exemplary embodiment of the present invention. This linear increasing of the output voltage corresponds to a gradual increase of the charging voltage Vbat of the high voltage battery 300, that is, a procedure where the high voltage battery 300 is being charged, as shown in FIG. 2C. Further, as shown in FIG. 2A, the output voltage VDC of the PFC converter 100 may be increased linearly based on the linear increasing of the charging voltage Vbat of the high voltage battery 300 to maximize the duty value of the DC/DC converter 200. As shown in graph \textcircled{1} the output voltage VDC of the PFC converter 100 may be substantially constant irrespective of time and thus the duty value of the DC-DC converter 200 may be gradually increased to reach to a maximum value. As shown in graph \textcircled{2}, the duty value of the DC-DC converter 200 may be initially at a maximum level thus, maximizing energy efficiency. Additionally, the time Tmax to reach the maximum value of the charging voltage Vbat of the high voltage battery 300 may be further reduced through the energy efficiency, as shown in FIG. 2C.

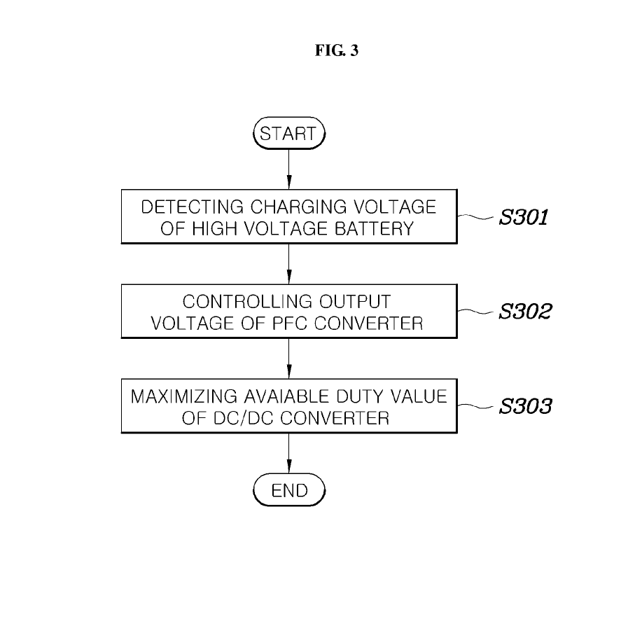

FIG. 3 is an exemplary flowchart of a charging method of a battery according to an exemplary embodiment of the present invention. Referring to FIG. 3, the charging voltage Vbat of the high voltage battery 300 may be sensed by a voltage sensor (not shown) (S301). The controller 400 may be configured to adjust the output voltage of the PFC converter 100 based on the detected charging voltage of the high voltage battery 300 (S302). The controller 400 may be configured to maximize the available duty value of the DC-DC converter 200 through the adjusted output voltage value (S303).

Further, the high voltage battery 300 may be charged by the DC-DC converter 200 and the charging voltage of the high voltage battery 300 may be varied linearly wherein the charging voltage Vbat of the high voltage battery 300 may be sensed again by a voltage sensor (not shown). The controller 400 may be configured to adjust the output voltage of the PFC converter 100 based on the detected charging voltage of the high voltage battery 300 and the available duty value of the DC-DC converter 200 may be maximized by the controller through the controlled output voltage value.

According to the present invention, a charging efficiency of a battery may be increased thereby reducing a charging time and improving fuel ratio of a vehicle which uses the battery.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the accompanying claims.

What is claimed is:

1. A charging system of a battery, comprising:
a PFC (Power Factor Correction) converter configured to convert alternating current input voltage into direct current voltage and output the direct current voltage, and correct a power factor;
a DC-DC (direct current-direct current) converter configured to vary levels of direct current voltage output from the PFC converter;
a battery configured to be charged with a current output from the DC/DC converter; and
a controller configured to adjust the output voltage of the PFC converter based on a charging voltage of the battery, varied by the charging and discharging of the battery.

2. The charging system of a battery of claim 1, wherein the controller is further configured to maximize an available duty value of the DC-DC converter by adjusting the output voltage of the PFC converter.

3. The charging system of a battery of claim 1, wherein an input voltage of the DC/DC converter is substantially similar to the output voltage of the PFC converter.

4. The charging system of a battery of claim 1, wherein the controller is further configured to adjust the output voltage of the PFC converter to be reduced as the charging voltage of the battery becomes substantially low.

5. A charging method of a battery, comprising:
detecting, by a voltage sensor, a charging voltage of a battery; and
adjusting, by a controller, an output voltage of a PFC (power factor correction) converter that converts alternating current input voltage into direct current voltage and outputs the direct current voltage based on the detected charging voltage.

6. The charging method of a battery of claim 5, further comprising:
maximizing, by the controller, an available duty value of a DC-DC (direct current-direct current) converter that uses the output voltage of the PFC converter as an input voltage based on the adjusted output voltage of the PFC converter.

7. The charging method of a battery of claim 5, wherein the input voltage of the DC-DC converter is substantially similar to the adjusted output voltage of the PFC converter.

8. The charging method of a battery of claim 5, further comprising:
reducing, by the controller, the output voltage of the PFC converter as the charging voltage of the battery becomes substantially low.

9. A non-transitory computer readable medium containing program instructions executed by a controller, the computer readable medium comprising:
program instructions that control a voltage sensor to detect a charging voltage of a battery; and
program instructions that adjust an output voltage of a PFC (power factor correction) converter that converts alternating current input voltage into direct current voltage and outputs the direct current voltage based on the detected charging voltage.

10. The non-transitory computer readable medium of claim 9, further comprising:
program instructions that maximize an available duty value of the DC-DC converter by adjusting the output voltage of the PFC converter.

11. The non-transitory computer readable medium of claim 9, wherein an input voltage of the DC/DC converter is substantially similar to the output voltage of the PFC converter.

12. The non-transitory computer readable medium of claim 9, further comprising:
program instructions that adjust the output voltage of the PFC converter to be reduced as the charging voltage of the battery becomes substantially low.
